(19) United States
(12) Patent Application Publication
(10) Pub. No.: US 2026/0363286 A1
(43) Pub. Date: Nov. 19, 2026

(54) A FLAVOR ENHANCER, METHODS OF PRODUCING THE SAME AND FOOD COMPRISING THE SAME

(71) Applicant: Cargill, incorporated, Wayzata, MN (US)

(72) Inventors: Junyin CHEN, Nantong (CN); Zhukun MA, Shanghai (CN); Zhenyu ZHAO, Dongguan (CN); Jinjin ZHOU, Shanghai (CN); Weilin XUE, Nantong (CN)

(73) Assignee: Cargill, incorporated, Wayzata, MN (US)

(21) Appl. No.: 19/132,419

(22) PCT Filed: Nov. 30, 2022
(86) PCT No.: PCT/CN2022/135471

§ 371 Date: May 23, 2025

(51) Int. Cl. A23L 27/00

(52) U.S. Cl. CPC A23L 27/88

(57) ABSTRACT

A method of producing a flavor enhancer comprises providing a first mixture by adding 0-70 wt % of water, 30-99 wt % of a dairy product, and 0.5-5 wt % of an emulsifier, relative to a weight of the flavor enhancer; adding 0.01-3 wt % of lipase and 0-0.5 wt % of protease to the first mixture for enzymolysis to form a second mixture, relative to the weight of the flavor enhancer; and controlling acid value of the second mixture to be in a range of 10-50 mg KOH/g.

### FIELD OF THE INVENTION

The present invention relates to a flavor enhancer. In particular, the invention relates to a method of producing the flavor enhancer and a food product comprising the flavor enhancer.

### BACKGROUND

Dairy products are derived from milk. These include products made from milk, such as cheese, yogurt, kefir, ice cream and butter. The major components of milk are water, fat, protein, carbohydrate (lactose) and minerals.

Improvements to food products can include, for example, improving the mouthfeel, flavor, look, and/or shelf-life of a product, reducing calories, and keeping raw material production costs low. To achieve these improvements in food products, food manufacturers may seek to use substitutes to traditional materials, which can impart improved qualities in a better or more efficient manner and/or can provide the same qualities at a reduced cost. At the same time, however, the appetizing nature and overall appearance of the food products should be maintained or even enhanced. Additionally, food manufacturers also seek ways to produce naturally-sourced and clean-label food products to satisfy increasing consumer demand for healthy and natural foods.

It is desirable to have dairy flavor in some food products, such as vegetable shortening/margarine. At present, dairy products are added to food products to provide the unique rich and milky flavor. However, the addition of dairy products to the food products may increase the production costs. Alternatively, artificial flavorings may be added to bring the desired flavor to a food product. However, it is not preferable for the sake of clean label.

Therefore, there is a need for a flavor enhancer that provides rich and milky flavor to food products and replaces artificial flavorings in the food products.

### SUMMARY

To overcome the deficiencies as discussed above, the present invention provides a flavor enhancer, and a method for producing the flavor enhancer.

The present invention provides a method of producing a flavor enhancer, comprising: providing a first mixture by adding 0-70 wt % of water, 30-99 wt % of a dairy product, and 0.5-5 wt % of an emulsifier, relative to a weight of the flavor enhancer; adding 0.01-3 wt % of lipase and 0.0-0.5 wt % of protease to the first mixture for enzymolysis to form a second mixture, relative to the weight of the flavor enhancer; and controlling acid value of the second mixture to be in a range of 10-50 mg KOH/g, preferably 20-50 mg KOH/g so that the flavor enhancer is obtained.

The present invention provides a flavor enhancer produced by the method discussed herein.

The present invention also provides a food comprising the flavor enhancer.

Other example embodiments are discussed herein.

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the singular forms “a,” “an,” and “the” include plural referents unless the context clearly dictates otherwise. For example, reference to “a substituent” encompasses a single substituent as well as two or more substituents, and the like. It is understood that any term in the singular may include its plural counterpart and vice versa.

The term “or” is used to refer to a nonexclusive “or” unless otherwise indicated. The statement “at least one of A and B” has the same meaning as “A, B, or A and B.”

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

As used herein, the terms “for example, “for instance,” “such as,” “e.g.”, or “including” are meant to introduce examples that further clarify more general subject matter. Unless otherwise specified, these examples are provided only as an aid for understanding the applications illustrated in the present disclosure, and are not meant to be limiting in any fashion.

The term “about” as used herein can allow for a degree of variability in a value or range, for example, within 10%, within 9%, within 8%, within 7%, within 6%, within 5%, within 4%, within 3%, within 2%, or within 1% of a stated value or of a stated limit of a range, and includes the exact stated value or range.

The present invention provides a method of producing a flavor enhancer, comprising: providing a first mixture by adding about 0-70 wt % of water, about 30-99 wt % of a dairy product, and about 0.5-5 wt % of an emulsifier, relative to a weight of the flavor enhancer; adding about 0.01-3 wt % of lipase and about 0.0-0.5 wt % of protease to the first mixture for enzymolysis to form a second mixture, relative to the weight of the flavor enhancer; and controlling acid value of the second mixture to be in a range of about 10-50 mg KOH/g, preferably about 20-50 mg KOH/g so that the flavor enhancer is obtained.

In one aspect, the term “flavor enhancer” refers to a dairy product processed by a method which enhances or intensifies the perception of a particular flavor or odor of the dairy product without being processed by the method or the unprocessed dairy product. In a further aspect, the particular flavor or odor refers to the creamy, salty, buttery, sour, cheesy, ripe, aged, tangy, or savory flavor/odor of the dairy product, or any combination thereof. In one aspect, the flavor enhancer is a natural flavor product. In one aspect, the flavor enhancer is used to replace a chemical synthetic flavor in food. The flavor enhancer can impart the food a richer and full milky flavor compared to unprocessed dairy products or other chemical synthetic flavors. In a further aspect, the richer and full milky flavor means the enhanced creamy, salty, buttery, sour, cheesy, ripe, aged, tangy, and/or savory flavor/odor of food, compared to unprocessed dairy products. In another aspect, inclusion of the flavor enhancer in the food can reduce the added amount of dairy products in the food formula to reduce the cost.

In one aspect, the term “dairy product” refers to any of the foods made from milk. In another aspect, dairy product includes milk (including cow milk, sheep milk, goat milk, etc.), cheese, butter (including salted butter or unsalted butter), and any combination thereof. In a preferred aspect, dairy product includes liquid milk, cheese powder, milk powder, or butter, or any combination thereof.

In one aspect, the dairy product includes or consists of about 10-20 wt % of cheese powder, about 5-15 wt % of milk powder, and about 25-40 wt % of butter, relative to the weight of flavor enhancer. In another aspect, the dairy product includes or consists of about 30-60 wt % of cheese powder, relative to the weight of flavor enhancer. In another aspect, the dairy product includes or consists of about 80-90 wt % of butter, relative to the weight of flavor enhancer. In another aspect, the dairy product includes or consists of about 30-45 wt % of liquid milk, about 10-20 wt % of milk powder and about 35-50 wt % of butter, relative to the weight of flavor enhancer.

In one aspect, the dairy product includes or consists of about 15 wt % of cheese powder, about 9.3 wt % of milk powder, and about 33.6 wt % of butter, relative to the weight of flavor enhancer. In another aspect, the dairy product includes or consists of about 50 wt % of cheese powder. In another aspect, the dairy product includes or consists of about 38.61 wt % of milk, about 14.5 wt % of milk powder and about 43.64 wt % of butter, relative to the weight of flavor enhancer. In another aspect, the dairy product includes or consists of about 86.7 wt % of butter, relative to the weight of flavor enhancer.

In one aspect, the first mixture includes or consists of water, dairy product and emulsifier. In one aspect, water is added in the first mixture in an amount of about 0-70 wt %, about 5-60 wt %, about 5-65 wt %, about 10-60 wt %, about 15-55 wt %, about 20-50 wt %, about 25-45 wt %, about 0-46.75 wt %, about 0-38.7 wt %, or about 38.7-46.75 wt %, relative to the weight of the flavor enhancer.

In one aspect, the dairy product is added in the first mixture in an amount of about 30-99 wt %, about 30-95 wt %, about 35-90 wt %, about 40-90 wt %, about 40-86.7 wt %, about 40-80 wt %, about 40-75 wt %, about 50-96.75 wt %, about 50-57.9 wt %, or about 57.9-96.75 wt %, relative to the weight of the flavor enhancer.

In one aspect, an emulsifier is added in the first mixture to make the mixture form a uniform emulsion and avoid oil-water separation, and precipitation, thereby improving the product quality and extend shelf life. In one aspect, the emulsifier is saturated monoglyceride. In another aspect, the emulsifier is selected from any commercially available emulsifiers. Exemplary emulsifiers include but not limited to lecithin, mono-and/or di-glycerides, ammonium phosphatide, propane- 1,2-diol esters of fatty acids, sucrose esters of fatty acids, sucroglycerides, polyglycerol esters of fatty acids, polyglycerol polyricinoleate sorbitan esters, sorbitan tristearate, stearoyl-2-lactylates, and mixtures of two or more thereof. In one aspect, emulsifier is added in the first mixture in an amount of about 0.5-5 wt %, about 0.5-4.5 wt %, about 0.5-4 wt %, about 0.5-3 wt %, about 0.5-2 wt %, about 1 wt % relative to the weight of the flavor enhancer.

In one aspect, the first mixture includes or consists of about 5-60 wt % of water, about 40-90 wt % of the dairy product, and about 0.5-1.5 wt % of the emulsifier, relative to the weight of the flavor enhancer. In one aspect, the first mixture includes or consists of about 30-60 wt % of water, about 40-70 wt % of the dairy product, and about 0.5-1.5 wt % of the emulsifier, relative to the weight of the flavor enhancer. In another aspect, the first mixture includes or consists of about 40-50 wt % of water, about 50-97 wt % of the dairy product, and about 0.5-1.5 wt % of the emulsifier, relative to the weight of the flavor enhancer. In another aspect, the first mixture includes 0.0 wt % of water, about 90-97 wt % of the dairy product, and about 0.5-1.5 wt % of the emulsifier, relative to the weight of the flavor enhancer. In a further aspect, the emulsifier is about 1 wt %, relative to the weight of the flavor enhancer.

After the first mixture is obtained, about 0.01-3 wt % of lipase and 0.0-0.5 wt % of protease are added to the first mixture for enzymolysis to form a second mixture. In one aspect, no protease is added to the first mixture.

Lipases are classically defined as enzymes that catalyze the hydrolysis of fats into free fatty acids and monoglycerides, etc. Proteases are enzymes that catalyze proteolysis, breaking down proteins into smaller polypeptides or single amino acids, and spurring the formation of new protein products.

In one aspect, the lipase is derived from Rhizopus or Aspergillus. In one aspect, the protease is derived from Aspergillus. In another aspect, the lipase is selected from a group consisting of Aspergillus niger lipase (such as lipase A12), Rhizopus oryzae lipase (such as lipase MER), Rhizopus niveus lipase (such as lipase Newlase F3G), and any combination thereof. In another aspect, the protease is Aspergillus oryzae protease (such as protease AAmano 2SD).

In one aspect, lipase is added in an amount of about 0.01-3 wt %, about 0.02-3 wt %, about 0.03-3 wt %, about 0.05-3 wt %, about 0.5-2 wt %, about 0.1-0.2 wt %, about 0.2-0.3 wt %, about 0.09-0.2 wt %, about 0.09-0.1 wt %, relative to the weight of the flavor enhancer. In one aspect, the lipase is about 0.05-0.5 wt % of Aspergillus niger lipase, relative to the weight of the flavor enhancer. In another aspect, the lipase is about 0.02-0.2 wt % of Rhizopus niveus lipase and about 0.005-0.1 wt % of Rhizopus oryzae lipase, relative to the weight of the flavor enhancer. In another aspect, the lipase is about 0.02-0.2 wt % of Rhizopus niveus lipase and 0.005-0.05 wt % of Rhizopus oryzae lipase, relative to the weight of the flavor enhancer. In another aspect, the lipase is about 0.03-0.3 wt % of Rhizopus niveus lipase, relative to the weight of the flavor enhancer.

In one aspect, protease is added in an amount of about 0.0-0.5 wt %, about 0.01-0.5 wt %, about 0.02-0.4 wt %, about 0.05-0.3 wt %, about 0.05-0.2 wt %, or about 0.05-0.1 wt %, relative to the weight of the flavor enhancer. In another aspect, no protease is added into the first mixture. In one aspect, the protease is about 0.0-0.5 wt %, about 0.01-0.5 wt %, about 0.05-0.1 wt %, or about 0.01-0.05 wt % of Aspergillus oryzae protease, relative to the weight of the flavor enhancer.

In one aspect, the lipase is about 0.05-0.5 wt % of Aspergillus niger lipase; or the lipase is about 0.02-0.2 wt % of Rhizopus niveus lipase and about 0.005-0.1 wt % of Rhizopus oryzae lipase; or the lipase is about 0.03-0.3 wt % of Rhizopus niveus lipase, relative to the weight of the flavor enhancer; and the protease is about 0.01-0.5% wt % of Aspergillus oryzae protease. In another aspect, the lipase is about 0.03-0.3 wt % of Rhizopus niveus lipase, relative to the weight of the flavor enhancer; and no protease is added.

In another aspect, the lipase is about 0.1-0.5 wt %, or about 0.1-0.2 wt % of lipase A12, and the protease is about 0.01-0.5 wt %, or about 0.05-0.1 wt % of Aspergillus oryzae protease. In another aspect, the lipase is about 0.01-0.5 wt %, or about 0.07-0.1 wt % of lipase Newlase F3G, and about 0.01-0.5 wt % or about 0.02-0.1 wt % of lipase MER, and the protease is about 0.01-0.5 wt %, or about 0.05-0.1 wt % of Aspergillus oryzae protease. In another aspect, the lipase is about 0.01-0.5 wt %, or about 0.07-0.1 wt % of lipase Newlase F3G, and the protease is about 0.01-0.5 wt %, or about 0.05-0.1 wt % of Aspergillus oryzae protease. In another aspect, the lipase is about 0.01-0.2 wt %, or about 0.07-0.2 wt %, or about 0.2-0.3 wt % of lipase Newlase F3G and no protease is added.

After adding the lipase and/or protease, the enzymolysis is conducted to form a second mixture. In one aspect, the enzymolysis is conducted at a temperature of about 25-58 °C (or 30-50 °C or 35-45 °C) for about 1-12 hours (or 1-10 hours or 2-8 hours) (preferably with stirring) to form a second mixture. In one aspect, the acid value of the second mixture is controlled to be in a range about 10-50 mg KOH/g, preferably about 20-50 mg KOH/g. Constant stirring can be employed during the enzymolysis.

In one aspect, after a step of controlling acid value of the second mixture to be in a range of about 10-50 mg KOH/g, preferably about 20-50 mg KOH/g, a preservative agent, an acidity regulator and whey are added to the second mixture; and then the lipase and the protease (if any) are inactivated so that the flavor enhancer is obtained.

Preservative agents are used primarily to prevent or retard microbial growth and to prolong shelf life. The preservative agent used can be any preservative agents that are known in the art or any combination thereof. In one aspect, the preservative agents are those used in food, such as sorbic acid, benzoic acid, propionic acid, and methyl-, ethyl- and propyl-esters of p-hydroxybenzoic acid (PHB, parabens). Preferably, the preservative agent is potassium sorbate. In one aspect, the preservative agent is added in an amount of about 0.01-2 wt %, about 0.01-1 wt %, about 0.02-0.5 wt %, about 0.02-0.3 wt %, about 0.05-0.2 wt %, about 0.02-0.18 wt %, about 0.02-0.09 wt %, or about 0.09-0.18 wt %, relative to the weight of the flavor enhancer. In another aspect, the preservative agent is about 0.02-0.18 wt % of potassium sorbate aqueous solution, relative to the weight of the flavor enhancer.

In one aspect, acidity regulator is added to control the rate of the reaction. Acidity regulator also increases the acidity of a foodstuff or is used to improve the organoleptic quality of a product by imparting it with an acid flavor. They are often organic acids such as ascorbic, citric, or acetic acids. Acidity regulators also include phosphates and phosphoric acid. In one aspect, the acidity regulator is citric acid, which can also preserve and prolong shelf life. In another aspect, additional acidity regulator is added. In one aspect, acidity regulator is added in an amount of about 0.001-0.1 wt %, about 0.001-0.05 wt %, about 0.002-0.05 wt %, about 0.005-0.03 wt %, about 0.005-0.02 wt %, about 0.001-0.01 wt %, or about 0.01-0.05 wt %, relative to the weight of the flavor enhancer.

In one aspect, whey is added in an amount of about 0.1-10 wt %, about 0.5-10 wt %, about 0.5-5 wt %, about 1-5 wt %, about 2-5 wt %, about 0.1-2 wt %, or about 2-10 wt %, relative to the weight of the flavor enhancer. In one aspect, the whey is desalted whey powder.

In one aspect, the preservative agent is about 0.02-0.18 wt % of potassium sorbate aqueous solution, and the acidity regulator is about 0.001-0.05 wt % of citric acid aqueous solution, and the whey is about 0.1-10 wt % of desalted whey powder, relative to the weight of the flavor enhancer. In another aspect, the preservative agent is about 0.05-0.15 wt % of potassium sorbate aqueous solution, and the acidity regulator is about 0.005-0.03 wt % of citric acid aqueous solution, and the whey is about 1-5 wt % of desalted whey powder, relative to the weight of the flavor enhancer.

In one aspect, the enzymes in the second mixture can be inactivated by any conventional means in the art so as to obtain a flavor enhancer. Conventional method for inactivating enzyme includes but not limited to thermal treatment, cooking, drying, cooling, freezing, pulsed electric field (PEF), high-pressure processing (HPP) ultraviolet, ohmic heating, and dense-phased carbon dioxide treatment. In one aspect, the enzymes are inactivated by maintaining the temperature at about 80 °C and stirring for about 25 minutes.

In one aspect, the mixture after inactivation of enzymes is cooled down to 30-40 °C and packed to obtain the flavor enhancer.

The present invention also provides a flavor enhancer produced from the method discussed herein. It has been surprisingly discovered that controlling the acid value of the dairy products (such as cheese powder, milk powder, butter, and liquid milk) after the enzymolysis by lipase and/or protease to be 10-50 mg KOH/g (preferably 20-50 mg KOH/g) provides an enhanced creamy, salty, buttery, sour, cheesy, ripe, aged, tangy, and/or savory flavor/odor, compared to the dairy products without being processed by the method of the present invention, or unprocessed dairy products. Controlling the acid value to 20-50 mg KOH/g provides an even more enhanced flavor/odor as discussed above.

The present invention also provides a food that includes the flavor enhancer obtained from the method of the present invention. In one aspect, the food includes about 0.001-5 wt %, about 0.001-4.5 wt %, about 0.005-4.5 wt %, about 0.01-4 wt %, or about 0.1-5 wt % of the flavor enhancer, relative to the weight of the food, and further includes custard cream, shortening, vegetable oils, margarine, non-dairy creamer, and/or non-dairy topping.

Surprisingly, it has been discovered that the addition of a small amount (e.g. 0.001-5 wt %) of flavor enhancer can bring richer and full milky flavor to a food compared to the dairy products without being processed by the method or other food with only chemical synthetic flavors. Advantageously, the flavor enhancer of the present invention can replace at least a part of raw material of dairy products (i.e. milk powder, butter, milk and cheese product) in food and meanwhile provide the food with a rich and milky flavor/taste, thereby reducing the production cost of the food product. Preferably, the flavor enhancer of the present invention can replace at least a part of the artificial flavorings that would otherwise need to be added to provide rich and milky flavor/odor to a food product, which is desirable in terms of clean label for food products.

Certain specific aspect of the present inventions and embodiments of the present application will be explained in greater detail with reference to the following examples, which are provided only for purposes of illustration and should not be construed as limiting the scope of the application in any manner.

Reasonable variations of the described procedures are intended to be within the scope of the present invention. While particular aspect of the present inventions of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The invention will now be illustrated in the following examples.

### EXAMPLES

The following examples are presented to further illustrate and explain the present invention and should not be taken as limiting in any regard.

### Example 1—Evaluation Methods

A sensory evaluation group composed of 8 persons who have completed the training and been qualified for the evaluation in Cargill lab for 1-8 years. The group evaluated the samples based on the odor/aroma and flavor of the samples.

Odor/Aroma refers to all olfactory sensation detected through orthonasal olfaction by sniffing. Flavor refers to the olfactory sensation that the odor molecules return to the nasal cavity after the sample in mouth, which is all the olfactory sensation perceived by the retronasal olfaction.

The evaluation methods and the descriptors are listed in Table 1 below.

TABLE 1
Evaluation method and descriptor

| Evaluation Method | Descriptor | Definition |
|---|---|---|
| 1. Odor/Aroma | Overall odor | The intensity of the overall |
| Assess the odor of the | intensity | odor of the sample that can |
| sample by sniffing the | | be perceived when the |
| sample while shaking | | sample is smelled. |
| the sample cup. | Aroma - Butter | Used to describe the smell |
| | | of butter that can be |
| | | perceived when a sample is |
| | | sniffed. |
| | Aroma - Cream | Used to describe the |
| | | creamy smell that can be |
| | | perceived when a sample is |
| | | sniffed. |
| | Aroma - Sour | Used to describe the acid |
| | | odor that can be perceived |
| | | when a sample is sniffed. |
| | Aroma - cheese | Used to describe the odor |
| | | of cheese that can be |
| | | perceived when a sample is |
| | | sniffed. |
| | Aroma - Salty | Used to describe the salty |
| | Aroma | odor that a product can |
| | | perceive when smelling a |
| | | sample. |
| 2. Flavor | Overall flavor | The intensity of the overall |
| Take a sip of the | intensity | flavor of the sample that |
| sample, use the | | can be perceived when the |
| tongue to fully | | sample is tasted. |
| disperse the sample in | Flavor - Butter | Used to describe the taste |
| the mouth, evaluate | flavor | of butter that can be |
| the flavor profile | | perceived when a sample is |
| of the sample and | | tasted. |
| spit out | Flavor - cream | Used to describe the taste |
| the sample. | | of cream that can be |
| | | perceived when a sample is |
| | | tasted. |
| | Flavor - sour | Used to describe the sour |
| | | taste that can be perceived |
| | | when a sample is tasted. |
| | Flavor - cheese | Used to describe the taste |
| | | of cheese that can be |
| | | perceived when a sample is |
| | | tasted. |
| | Flavor - salty | Used to describe the savory |
| | | taste that a taster can |
| | | perceive when tasting a |
| | | sample. |

Methods and tips for odor/aroma evaluation:
(1) Liquid samples can be kept in a sniff bottle or strip, solid or semi-solid should be properly stirred or cut in advance to provide a fresh surface
(2) One finger distance from the sample to the nose (wave your hand over the product to make the smell drift towards you, please do not put your nose close to the product to inhale deeply)
(3) Repeat long or short sniffing with the same times to different samples during comparison
(4) The sense of smell is easy to fatigue, don't keep sniffing a product, do not rush to do deep breathing
(5) Take a rest between samples, smell the back of your hand or a paper towel without fragrance, or relax in a place with fresh air and take deep breaths to accelerate the air exchange in the nasal cavity to help recovery.

Methods and tips for flavor evaluation:
(1) Liquid sample: drink enough amount of sample (10 20 ml), fully contact with the tongue and the surface of oral cavity, stay for about 3 seconds to fully release the volatile substances
(2) Solid sample: Take a bite of the sample (fill half of the mouth), so that the nasal cavity and oral cavity have air connection. When put the sample into mouth, the air flows back into the nasal cavity to perceive a richer flavor characteristic. Try breathing with your mouth open
(3) Flavor evaluation and techniques can refer to that of aroma to a certain extent. For example, when the smell is weak, we can also heat the product through the mouth by tasting it Note: Volatile compounds perceived in the mouth may differ from those perceived in the nose.

The sensory evaluation group evaluated the samples and provided descriptions on how they perceived the samples. The sensory descriptions are provided based on the comprehensive assessment of the intensity of both odor and flavor perceived from the samples.

The sensory evaluation group also ranked the odor/aroma and flavor of the samples based on the descriptors and the methods stated in Table 1. The samples are ranked according to the intensity of their odor and flavor. For example, if there are three samples, “1” means the slightest and mildest odor and flavor perceived among these three samples; “3” means the strongest odor and flavor perceived among these three samples; and “2” means the medium intensity of odor and flavor perceived among these three samples.

The ranking can be calculated by conventional statistic methods.

The above evaluation methods are used in the following examples.

### Example 2—Formula 1

The ingredients of the flavor enhancer are listed in Table 2 and its sensory description is shown in Table 3.

TABLE 2
Ingredients of formula 1
Formula 1

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Water | 38.700% | 38.700% | 38.700% |
| Cheese powder | 15.000% | 15.000% | 15.000% |
| Milk powder | 9.300% | 9.300% | 9.300% |
| Unsalted Butter | 33.600% | 33.600% | 33.600% |
| Saturated | 1.000% | 1.000% | 1.000% |
| monoglyceride | | | |
| Amano lipase | 0.000% | 0.200% | 0.200% |
| A12 | | | |
| Protease A | 0.000% | 0.100% | 0.100% |
| “Amano”2SD | | | |
| Desalted whey | 2.000% | 2.000% | 2.000% |
| powder | | | |
| Potassium | 0.090% | 0.090% | 0.090% |
| sorbate | | | |
| Citric acid | 0.010% | 0.010% | 0.010% |

TABLE 3
Sensory results of formula 1

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Sensory | Mild buttery, | Creamy, buttery, | Creamy, buttery, |
| description | slightly sour, | cheesy, rich and | cheesy, strong |
| | creamy, cheesy | sour | and sour |
| Rank | 1 | 2 | 3 |

Table 3 shows that when the dairy product of formula 1 does not go through enzymolysis (i.e. before reaction), the terms “mild” and “slight” existed in the sensory description (i.e. rank 1). When the dairy product of formula 1 was treated by the method of the present invention with acid value controlled to be 10-19.9 mg KOH/g, the sensory description demonstrates an enhanced odor and flavor (i.e. rank 2). When the dairy product of formula 1 was treated by the method of the present invention with acid value controlled to be 20-50 mg KOH/g, the term “strong” existed in the sensory description (i.e. rank 3).

Table 3 shows that the odor and flavor of formula 1 after enzymolysis reaction with acid value of 10-50 mg KOH/g has been enhanced compared to that before reaction. When the acid value is controlled to 20-50 mg KOH/g, the odor and flavor of formula 1 has been enhanced to even a higher level of intensity than that with acid value of 10-19.9 mg KOH/g.

### Example 3—Formula 2

The ingredients of the flavor enhancer are listed in Table 4 and its sensory description is shown in Table 5.

TABLE 4
Ingredients of formula 2
Formula 2

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Water | 46.750% | 46.750% | 46.750% |
| Cheese powder | 50.000% | 50.000% | 50.000% |
| Saturated | 1.000% | 1.000% | 1.000% |
| monoglyceride | | | |
| Amano lipase | 0.000% | 0.070% | 0.070% |
| Newlase F3G | | | |
| Amano lipase | 0.000% | 0.020% | 0.020% |
| MER | | | |
| Protease A | 0.000% | 0.050% | 0.050% |
| “Amano”2SD | | | |
| Desalted whey | 2.000% | 2.000% | 2.000% |
| powder | | | |
| Potassium | 0.090% | 0.090% | 0.090% |
| sorbate | | | |
| Citric acid | 0.010% | 0.010% | 0.010% |

TABLE 5
Sensory result of formula 2

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Sensory | slightly | Ripe, salty, | Aged, tangy, |
| description | cheesy | creamy, | savory, creamy, |
| | | cheesy | cheesy |
| Rank | 1 | 2 | 3 |

Table 5 shows that when the dairy product of formula 2 does not go through enzymolysis (i.e. before reaction), the term “slightly cheesy” existed in the sensory description (i.e. rank 1). When the dairy product of formula 2 was treated by the method of the present invention with acid value controlled to be 10-19.9 mg KOH/g, the term “ripe” existed in the sensory description, meaning the odor and flavor has been enhanced (i.e. rank 2), and the cheese flavor is not as strong as when the acid value is in the range of 20-50 mg KOH/g. When the dairy product of formula 2 was treated by the method of the present invention with acid value controlled to be 20-50 mg KOH/g, the terms “aged” and “tangy” existed in the sensory description (i.e. rank 3).

Table 5 shows that the odor and flavor of formula 2 after enzymolysis reaction with acid value of 10-50 mg KOH/g has been enhanced compared to that before reaction. When the acid value is controlled to 20-50 mg KOH/g, the odor and flavor of formula 2 has been enhanced to even a higher level of intensity than that with acid value of 10-19.9 mg KOH/g.

### Example 4—Formula 3

The ingredients of the flavor enhancer are listed in Table 6 and its sensory description is shown in Table 7.

TABLE 6
Ingredients of formula 3
Formula 3

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Liquid Milk | 38.610% | 38.610% | 38.610% |
| Milk powder | 14.500% | 14.500% | 14.500% |
| Unsalted Butter | 43.640% | 43.640% | 43.640% |
| Saturated | 1.000% | 1.000% | 1.000% |
| monoglyceride | | | |
| Amano lipase | 0.000% | 0.100% | 0.100% |
| Newlase F3G | | | |
| Protease A | 0.000% | 0.050% | 0.050% |
| “Amano”2SD | | | |
| Desalted whey | 2.000% | 2.000% | 2.000% |
| powder | | | |
| Potassium | 0.090% | 0.090% | 0.090% |
| sorbate | | | |
| Citric acid | 0.010% | 0.010% | 0.010% |

TABLE 7
Sensory result of formula 3

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Sensory | mild and | Creamy, slightly | Creamy, buttery, |
| description | creamy | sour butter | intensely rich |
| | | | sour cream |
| Rank | 1 | 2 | 3 |

Table 7 shows that when the dairy product of formula 3 does not go through enzymolysis (i.e. before reaction), the term “mild” existed in the sensory description (i.e. rank 1). When the dairy product of formula 3 was treated by the method of the present invention with acid value controlled to be 10-19.9 mg KOH/g, “mild and creamy” has been enhanced to “creamy” and slightly sour butter existed in the sensory description (i.e. rank 2). When the dairy product of formula 3 was treated by the method of the present invention with acid value controlled to be 20-50 mg KOH/g, the term “intensely” existed in the sensory description (i.e. rank 3).

Table 7 shows that the odor and flavor of formula 3 after enzymolysis reaction with acid value of 10-50 mg KOH/g has been enhanced compared to that before reaction. When the acid value is controlled to 20-50 mg KOH/g, the odor and flavor of formula 3 has been enhanced to even a higher level of intensity than that with acid value of 10-19.9 mg KOH/g.

### Example 5—Formula 4

The ingredients of the flavor enhancer are listed in Table 7 and its sensory description is shown in Table 8.

TABLE 7
Ingredients of formula 4
Formula 4

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Water | 10.00% | 10.00% | 10.00% |
| Unsalted Butter or | 86.90% | 86.70% | 86.70% |
| anhydrous milk fat | | | |
| (Collectively known | | | |
| as butter) | | | |
| Saturated | 1.00% | 1.00% | 1.00% |
| monoglyceride | | | |
| Amano lipase | 0.00% | 0.20% | 0.20% |
| Newlase F3G | | | |
| Desalted whey | 2.00% | 2.00% | 2.00% |
| powder | | | |
| Potassium sorbate | 0.09% | 0.09% | 0.09% |
| Citric acid | 0.01% | 0.01% | 0.01% |

TABLE 8
Sensory result of formula 4

| | | After Reaction | After Reaction |
|---|---|---|---|
| | | (Acid value | (Acid value |
| | Before | 10-19.9 mg | 20-50 mg |
| | Reaction | KOH/g) | KOH/g) |
| Sensory | mild and | Creamy, slightly | Buttery, intensely |
| description | creamy | sour butter | rich creamy |
| Rank | 1 | 2 | 3 |

Table 8 shows that when the dairy product of formula 4 does not go through enzymolysis (i.e. before reaction), the term “mild” existed in the sensory description (i.e. rank 1). When the dairy product of formula 4 was treated by the method of the present invention with acid value controlled to be 10-19.9 mg KOH/g, the sensory description demonstrates an enhanced odor and flavor (i.e. rank 2). When the dairy product of formula 4 was treated by the method of the present invention with acid value controlled to be 20-50 mg KOH/g, the term “intensely” existed in the sensory description (i.e. rank 3).

Table 8 shows that the odor and flavor of formula 4 after enzymolysis reaction with acid value of 10-50 mg KOH/g has been enhanced compared to that before reaction. When the acid value is controlled to 20-50 mg KOH/g, the odor and flavor of formula 4 has been enhanced to even a higher level of intensity than that with acid value of 10-19.9 mg KOH/g.

1. A method of producing a flavor enhancer, comprising:
providing a first mixture by adding 0-70 wt % of water, 30-99 wt % of a dairy product, and 0.5-5 wt % of an emulsifier, relative to a weight of the flavor enhancer;
adding 0.01-3 wt % of lipase and 0.0-0.5 wt % of protease to the first mixture for enzymolysis to form a second mixture, relative to the weight of the flavor enhancer; and
controlling acid value of the second mixture to be in a range of 10-50 mg KOH/g, preferably 20-50 mg KOH/g so that the flavor enhancer is obtained.

2. The method of claim 1, wherein the dairy product includes liquid milk, cheese powder, milk powder, or butter, or any combination thereof.

3. The method of claim 1, wherein the enzymolysis is conducted at a temperature of 25-58 °C for 1-12 hours.

4. The method of claim 1, wherein after a step of controlling acid value of the second mixture to be in a range of 10-50 mg KOH/g, preferably 20-50 mg KOH/g, a preservative agent, an acidity regulator and whey are added to the second mixture; and then the lipase and the protease are inactivated so that the flavor enhancer is obtained.

5. The method of claim 4, wherein the preservative agent is 0.02-0.18 wt % of potassium sorbate aqueous solution, and the acidity regulator is 0.001-0.05 wt % of citric acid aqueous solution, and the whey is 0.1-10 wt % of desalted whey powder, relative to the weight of the flavor enhancer.

6. The method of claim 1, wherein the emulsifier is saturated monoglyceride.

7. The method of claim 1, wherein the first mixture includes 5-60 wt % of water, 40-90 wt % of the dairy product, and 0.5-1.5 wt % of the emulsifier.

8. The method of claim 7, wherein the dairy product includes 10-20 wt % of cheese powder, 5-15 wt % of milk powder, and 25-40 wt % of butter; or the dairy product includes 30-60 wt % of cheese powder; or the dairy product includes 80-90 wt % of butter.

9. The method of claim 1, wherein the first mixture includes 30-45 wt % of liquid milk, 10-20 wt % of milk powder and 35-50 wt % of butter.

10. The method of claim 1, wherein the lipase is derived from Rhizopus or Aspergillus; and the protease is derived from Aspergillus.

11. The method of claim 1, wherein the lipase is selected from a group consisting of Aspergillus niger lipase, Rhizopus oryzae lipase, Rhizopus niveus lipase, and any combination thereof; and the protease is Aspergillus oryzae protease.

12. The method of claim 1, wherein the lipase is 0.05-0.5 wt % of Aspergillus niger lipase; or the lipase is 0.02-0.2 wt % of Rhizopus niveus lipase and 0.005-0.1 wt % of Rhizopus oryzae lipase; or the lipase is 0.03-0.3 wt % of Rhizopus niveus lipase, relative to the weight of the flavor enhancer.

13. The method of claim 1, wherein the protease is 0.01-0.5 wt % of Aspergillus oryzae protease.

14. The method of claim 12, wherein the lipase is 0.03-0.3 wt % of Rhizopus niveus lipase, relative to the weight of the flavor enhancer, and no protease is added in the first mixture.

15. A flavor enhancer produced by the method of claim 1.

16. A food comprising the flavor enhancer of claim 15.

17. The food according to claim 16, wherein the food includes 0.001-5 wt % of the flavor enhancer, relative to a weight of the food, and further includes custard cream, shortening, vegetable oils, margarine, non-dairy creamer, and/or non-dairy topping.
